(19) United States
(12) Patent Application Publication
(10) Pub. No.: US 2014/0231157 A1
(43) Pub. Date: Aug. 21, 2014

(54) CONTINUOUS TRACK DRIVE SYSTEM FOR A VEHICLE

(71) Applicant: Edward George Green, Manzini (SZ)

(72) Inventor: Edward George Green, Manzini (SZ)

(21) Appl. No.: 14/348,171

(22) PCT Filed: Sep. 28, 2011
(86) PCT No.: PCT/IB2011/054263

§ 371 Date: Mar. 28, 2014

(51) Int. Cl. B62D 55/084; B62D 55/04; B62D 55/104; B62D 55/02

(52) U.S. Cl. CPC B62D 55/084; B62D 55/02; B62D 55/04; B62D 55/104
USPC 180/9.54; 180/9.5

(57) ABSTRACT

The invention provides a continuous track drive system (10) for cooperating with a pair of opposite drive wheels (18.1, 18.2) of a vehicle for converting the vehicle (12) into a half-track vehicle. In an operative configuration of the system, on each side of the vehicle, a continuous track (38) of the system runs around a drive wheel of the vehicle and a primary idler (36) of the system behind the drive wheel. The track defines between the wheel and the idler a bottom, traction run (40). A secondary idler (42) of the system bears against the outside of the track, at a position along a top run (46) of the track between the primary idler and the drive wheel, in a configuration in which the secondary idler induces and maintains an inward deflection or kink in the track for providing clearance between the track and the vehicle.

THIS INVENTION relates to a continuous track drive system for a vehicle.

The invention relates, more particularly, to a continuous track drive system for converting a wheel driven vehicle into a track driven vehicle. A continuous track, as referred to herein, may also be referred to as an endless track.

According to the invention there is provided a continuous track drive system for cooperating with a pair of opposite drive wheels of a vehicle, the system including:
a suspension system including:
   mounting means for mounting it to the vehicle; and
   a pair of idler carriers, one for each side of the vehicle; and
a pair of track systems, one for each side of the vehicle, each track system including:
   a continuous track;
   a primary idler having an outer diameter not exceeding 50% of the outer diameter of the corresponding drive wheel; and
   a secondary idler,
the continuous track drive system being configured to provide an operative configuration thereof on the vehicle in which:
   the suspension system is mounted to the vehicle; and
   on each side of the vehicle:
      the corresponding track system is mounted on the corresponding idler carrier and cooperates with the corresponding drive wheel of the pair of opposite drive wheels;
      the continuous track of the track system is curved around the drive wheel to be driven by the drive wheel;
      the primary idler of the track system is mounted on the idler carrier behind the drive wheel, the track being curved around the primary idler in a configuration in which a bottom run of the track, between the drive wheel and the primary idler, forms a traction run disposed for providing traction on terrain traversed by the vehicle; and
      the secondary idler of the track system is mounted on the idler carrier and bears against the outside of the track, at a position along a top run of the track between the primary idler and the drive wheel, in a configuration in which the secondary idler induces and maintains an inward deflection or kink in the track for providing clearance between the track and the vehicle.

In use of the drive system on the vehicle, the tracks are driven by the respective drive wheels with which they cooperate.

In a typical application envisaged for the drive system of the invention, the pair of opposite drive wheels with which it cooperates is a pair of rear wheels of the vehicle. Such a vehicle typically includes also a pair of front wheels, which are steering wheels and which optionally are drive wheels also. For use in snowy conditions, the vehicle may optionally be provided with conventional vehicle snow skids for supporting its front end.

In each track system, the fact that the primary idler has an outer diameter significantly smaller than that of the drive wheel with which it cooperates and the effect of the secondary idler hold a significant benefit in relation to a vehicle having a body including a body part, e.g. a rear part of a wheel arch, or an undercarriage part behind a top portion of the drive wheel. The secondary idler deflects the track with clearance around the said body part or undercarriage part. The diameter of the primary idler permits a configuration of the system in which clearance is provided between an underside of the vehicle and a run of the track between the primary idler and the secondary idler. This makes the drive system of the invention suitable for installation in many types of vehicles having bodies including such body parts or undercarriage parts, without requiring modification to the body of the vehicle to remove such part to provide clearance.

The drive system may be configured, particularly in respect of its connectors to the vehicle, to be fitted to the vehicle upon demand and to be removed when not required, thereby to restore the vehicle to normal operation when the drive system is not required. The system may be provided in a carrier case for facilitating transportation and storage.

The diameter of each primary idler may be between 25% and 50% of the outer diameter of the corresponding drive wheel.

Each track may be made at least predominantly of rubber. It may be a reinforced rubber track, e.g. reinforced by means of steel reinforcing.

Each track system may include a tertiary idler mounted, in the operative configuration, on the idler carrier on the inside of the track along the bottom run of the track for providing support to the vehicle on the track.

The suspension system may include a spring and damper arrangement configured for operatively acting between the vehicle and the primary idlers for providing support for the vehicle on the tracks via the primary idlers. The spring and damper arrangement may have mounting means for mounting it to the chassis of the vehicle.

The suspension system may include tensioning means for exerting, in the operative configuration, on each primary idler a force having a rearward component for tensioning the corresponding track. In the case of the pair of drive wheels with which the drive system operatively cooperates being a pair of rear wheels mounted on a fixed rear axle of the vehicle, the tensioning means may include mounting means for mounting it to the rear axle.

The drive system may include for each track at least one track guide positioned along an edge portion of the track for countering lateral displacement of the track.

The applicant believes that the continuous track drive system of the invention provides a practical means for converting a wheel driven vehicle into a half-track vehicle for enhanced traction of the vehicle. As such, the capability of the vehicle to negotiate low-traction terrain, e.g. snow-covered roads, sandy terrain, and muddy terrain may be enhanced. The system may be configured for use with any of a wide range of vehicles, including pickup trucks, passenger cars, and so forth.

Further features of the invention will become apparent from the description below of an embodiment of a continuous track drive system, in accordance with the invention, for a vehicle, with reference to and as illustrated in the accompanying diagrammatic figures. In the figures:

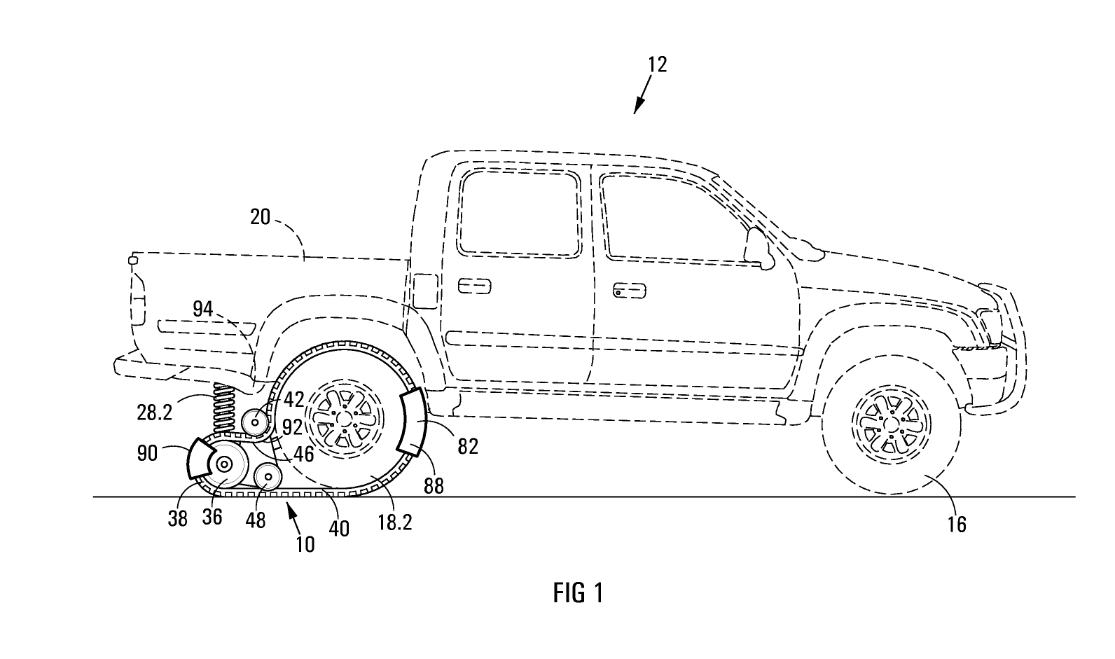

FIG. 1 shows a side view of a vehicle in the form of a pickup truck and a first embodiment of a continuous track drive system, in accordance with the invention, mounted to the truck and cooperating with a pair of opposite rear wheels, being drive wheels, of the truck;

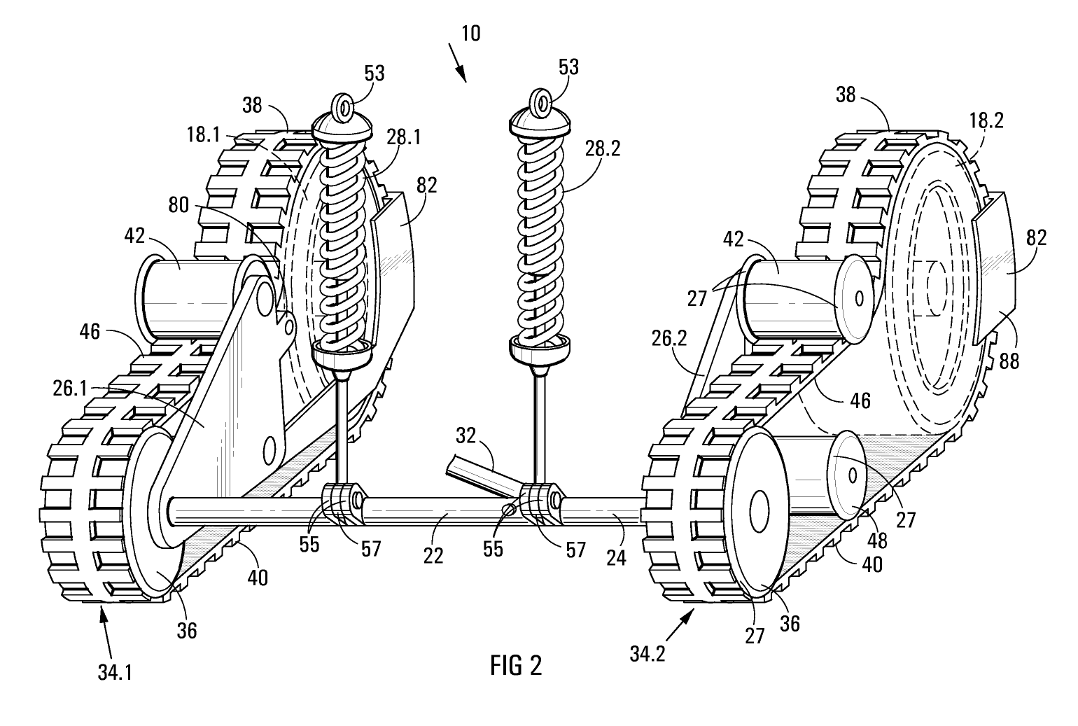

FIG. 2 shows a three-dimensional view of the continuous track drive system of FIG. 1 and the rear wheels of the truck of FIG. 1;

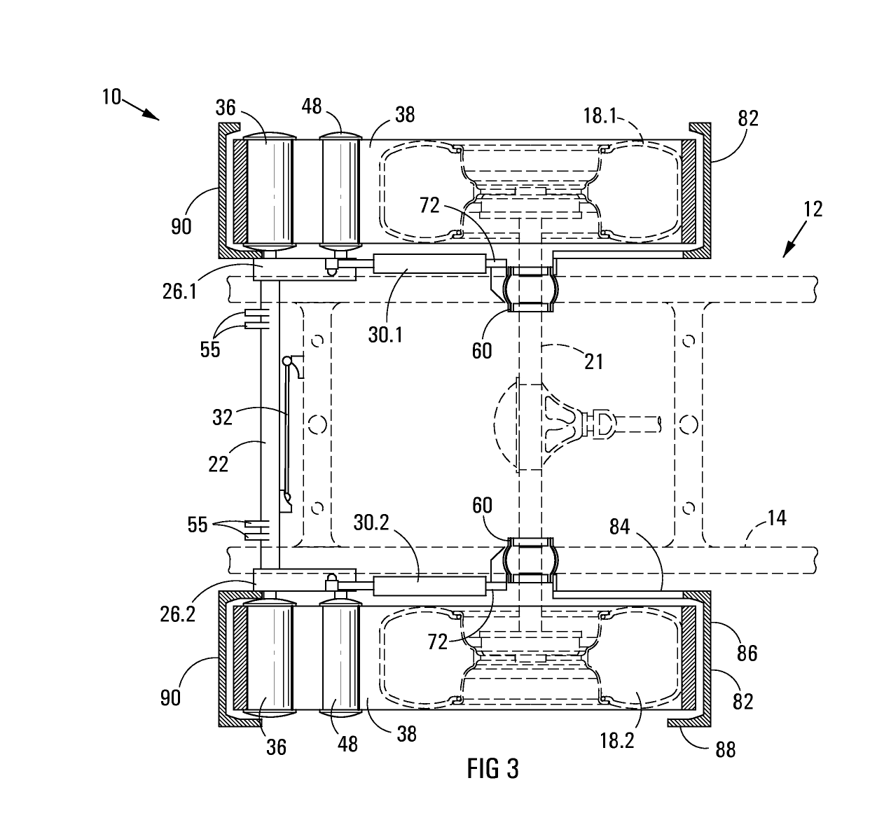

FIG. 3 shows a partial cut-away plan view of a part of the chassis of the truck of FIG. 1, the drive wheels of the truck, and certain components of the continuous track drive system of FIG. 1; and

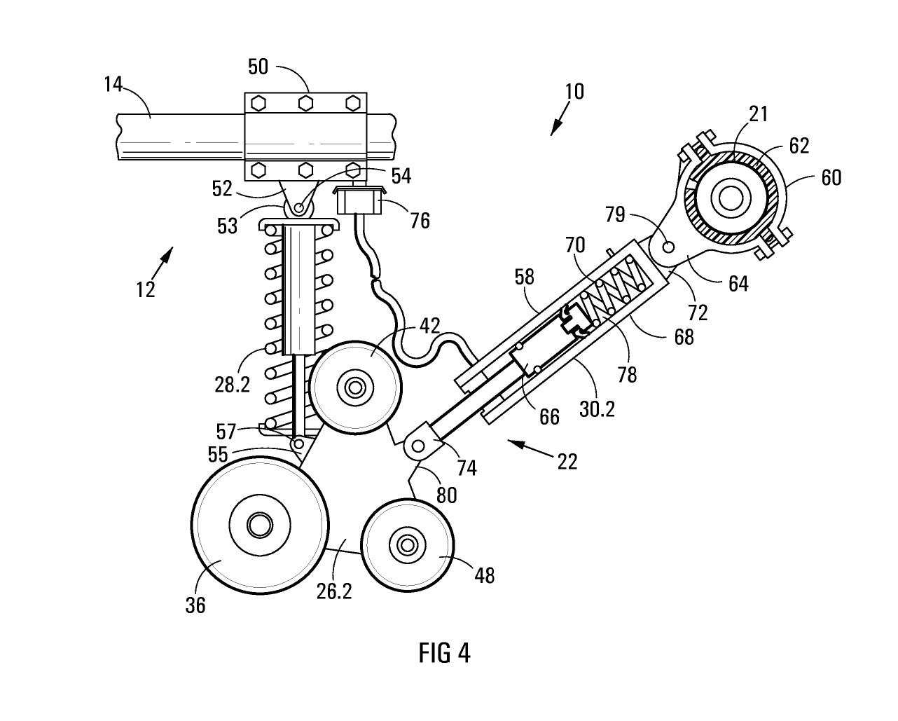

FIG. 4 shows a partial cut-away side elevation of an assembly forming a part of the continuous track drive system of FIG. 1.

In the figures, an embodiment of a continuous track drive system, in accordance with the invention, is designated generally by the reference numeral 10. The system 10 is shown mounted to a vehicle in the form of a pickup truck, designated generally by the reference numeral 12.

The truck 12 includes, conventionally:
a chassis 14 (FIGS. 3 and 4);
a pair of opposite front wheels 16 (only one shown);
a left rear drive wheel 18.1 and a right rear drive wheel 18.2;
a body 20;
a fixed rear axle 21; and
miscellaneous other components.

With reference particularly to FIGS. 2 and 4, the system 10 includes a suspension system 22, which includes:
a transverse strut 24;
a left idler carrier 26.1 and a mirroring right idler carrier 26.2;
a left spring and damper assembly 28.1 and a right spring and damper assembly 28.2;
tensioning means, including a left tensioner 30.1 and a right tensioner 30.2; and
a stabilizer 32.

The system 10 includes also a left track system 34.1 and a mirroring right track system 34.2. As the track systems 34.1 and 34.2 are mirroring, corresponding features are designated generally by the same reference numerals for both assemblies and only the assembly 34.2 is described below.

With reference to the figures generally, the track system 34.2 includes:
a primary idler 36, mounted on the idler carrier 26.2 behind and spaced apart from the wheel 18.2;
a steel reinforced rubber continuous track 38 curved around the wheel 18.2 and the primary idler 36, defining a bottom, ground contact run 40 extending between the wheel 18.2 and the idler 36;
a secondary idler 42, mounted on the idler carrier 26.2 and bearing against the outside of a top run 46 of the endless track 38 at a position between the idler 36 and the wheel 18.2; and
a tertiary idler 48 supportively mounted on the idler carrier 26.2 above the bottom run 40.

Each idler 36, 42, and 48 has two opposite guide flanges 27 to maintain alignment of the track 38.

The idler 36 has a diameter of approximately 50% of the outer diameter of the drive wheel with which it cooperates, i.e. the wheel 18.2. It is envisaged that, in most embodiments of the drive system of the invention, the diameter of the primary idler will be between 25% and 50% of the outer diameter of the wheel with which it cooperates.

With reference particularly to FIG. 4, the suspension system 22 includes a mounting bracket 50 for the spring and damper assembly 28.2, the bracket 50 being mounted on a longitudinal member of the chassis 14.

The bracket 50 and a top end of the spring and damper assembly 28.2 respectively include a clevis 52 and a complementary eye 53 via which the assembly 28.2 is removably connected to the bracket 50, by means of a clevis pin 54, to pivot about an axis transverse to the truck 12.

The strut 24 and a bottom end of the spring and damper assembly 28.2 include respectively a clevis 55 and a complementary eye 57 via which the assembly 28.2 is removably connected to the strut 24 by means of a clevis pin to pivot about an axis transverse to the truck 12.

With reference particularly to FIGS. 3 and 4, the tensioner 30.2 includes:
a piston/cylinder assembly 58; and
a mounting bracket 60, which is secured around a rubber bush around the axle 21 and which defines a clevis 64.
The piston/cylinder assembly 58 includes:
a piston member 66, including a clevis 74;
a cylinder member 68, including a lug 72;
an internal coil spring 70 in the cylinder member 68; and
internal pressurized nitrogen gas 78, having a breather 76 with a filter.

Via the clevis 74, the piston/cylinder assembly 58 is pivotally connected to a complementary lug 80 on the idler carrier 26.2 to pivot about an axis transverse to the truck 12.

Via the lug 72, the piston/cylinder assembly 58 is pivotally connected to the bracket 60 to pivot about an axis transverse to the truck 12. Such connection is by means of a clevis pin 79, which facilitates removal of the piston/cylinder assembly 58 from the bracket 60.

The spring 70 is preloaded so that it exerts opposite forces on the piston member 66 and the cylinder member 68, thereby urging the axle 21 and the idler carrier 26.2 apart. As such, a force having a rearward component is exerted on the idler 36, which causes the idler 36 to tension the track 38.

The tensioner 30.2 serves also as a damper via the pressurized nitrogen gas 78 therein. Details of the tensioner 30.2 are matters of design and development by those skilled in the art and are not elaborated on herein.

With reference to FIGS. 1 and 2, the suspension system 22 includes also a front guide member 82, which is mounted on the idler carrier 26.2. The guide member 82 includes:
an inner plate 84, mounted on and extending forwardly from the idler carrier 26.2;
a front plate 86, extending laterally outwardly from a front end of the plate 84 across the front of the track 38; and
an outer plate or lip 88 projecting rearwardly from an outer end of the plate 86.

There is limited clearance between each of the plates 84 and 88 and the track 38, the plates thus serving as stop formations for limiting lateral displacement of the track 58 on the wheel 18.2.

The suspension system 22 includes also a rear guide member 90, which is similar to the guide member 82 and which is omitted from FIG. 2. The guide member 90 serves to limit lateral displacement of the track 38 relative to the idler 36, should the track run over one of the flanges 27 of the idler 36 under excessive lateral load.

With reference to FIG. 3, the stabilizer 32 is pivotally mounted at opposite ends thereof to the transverse strut 24 and a transverse member of the chassis 14. The stabilizer 32 serves to limit lateral displacement of the strut 24 relative to the chassis 14.

The idler 42 serves to induce and maintain an inward deflection or kink 92 in the top run 46 of the track 38 between the idler 36 and the wheel 18.2. The kink 92 provides clearance between a rear part 94 of a wheel arch of the body 20 of the truck 12, behind a top portion of the wheel 18.2. Due to the deflection 92 induced and maintained by the idler 42, no modification was required to the body 12 for accommodating the system 10.

With reference to the figures generally, in use of the truck 12, the bottom run 40 of the track 38 is a traction run, which provides traction to the truck 12. The bottom run 40 is urged into contact with the terrain by the wheel 18.2 and the spring and damper assemblies 28.1 and 28.2 of the suspension system 22 of the system 10 acting on the idlers 36 and 48. The track 38 is friction driven by the wheel 18.2 under power of an engine of the truck 12. Optionally, a system alternative to the system 10 may have two tertiary idlers 48 spaced along the bottom run 40.

Further features of the operation of the system 10 will be understood by those skilled in the art of the invention and therefore does not require further elaboration herein. Suffice it to state that the truck 12, with the system 10 mounted thereto, is a half-track vehicle, the advantages of which will be understood by those skilled in the art of the invention.

Further features of the structure of the system 10, including materials suitable for manufacture of the respective components of the system, are matters for design and development and therefore do not require to be further elaborated on herein.

The system 10 may be fitted to the truck 12 upon demand and may be removed when not required. The various clevis pins via which the system 10 is connected to the mounting brackets 50 and 60 (see FIG. 4) facilitate connection and disconnection and a quick release connection will also be provided at the top of the stabilizer 32.

The applicant believes that the drive system of the invention may provide a practical means for converting a vehicle into a half-track vehicle, with its associated advantages, potentially providing a capital cost and/or operational cost advantage over a conventional four wheel drive vehicle. It requires no permanent modification to the vehicle, at least not externally, permitting the vehicle to be readily restored to its normal configuration if the system is not required. Of course, alternatively, the system of the invention may remain as a permanent installation on a vehicle.

1. A continuous track drive system for cooperating with a pair of opposite drive wheels of a vehicle, the system including:
a suspension system including:
mounting means for mounting it to the vehicle; and
a pair of idler carriers, one for each side of the vehicle; and
a pair of track systems, one for each side of the vehicle, each track system including:
a continuous track;
a primary idler having an outer diameter not exceeding 50% of the outer diameter of the corresponding drive wheel; and
a secondary idler,
the continuous track drive system being configured to provide an operative configuration thereof on the vehicle in which:
the suspension system is mounted to the vehicle; and
on each side of the vehicle:
the corresponding track system is mounted on the corresponding idler carrier and cooperates with the corresponding drive wheel of the pair of opposite drive wheels;
the continuous track of the track system is curved around the drive wheel to be driven by the drive wheel;
the primary idler of the track system is mounted on the idler carrier behind the drive wheel, the track being curved around the primary idler in a configuration in which a bottom run of the track, between the drive wheel and the primary idler, forms a traction run disposed for providing traction on terrain traversed by the vehicle; and
the secondary idler of the track system is mounted on the idler carrier and bears against the outside of the track, at a position along a top run of the track between the primary idler and the drive wheel, in a configuration in which the secondary idler induces and maintains an inward deflection or kink in the track for providing clearance between the track and the vehicle.

2. The drive system of claim 1, wherein the diameter of each primary idler is between 25% and 50% of the outer diameter of the corresponding drive wheel.

3. The drive system of any of the preceding claims, wherein each track system includes a tertiary idler mounted, in the operative configuration, on the idler carrier on the inside of the track along the bottom run of the track for providing support to the vehicle on the track.

4. The drive system of any of the preceding claims, wherein the suspension system includes tensioning means for exerting, in the operative configuration, on each primary idler a force having a rearward component for tensioning the corresponding track.

5. The drive system of claim 4, for the case of the vehicle having the pair of opposite drive wheels mounted on a fixed rear axle thereof, in which the tensioning means includes mounting means for mounting it to the fixed rear axle.

6. The drive system of any of the preceding claims, wherein the suspension system includes a spring and damper arrangement configured for operatively acting between the vehicle and the primary idlers for providing support for the vehicle on the tracks via the primary idlers.

7. The drive system of claim 6, wherein the spring and damper arrangement has mounting means for mounting it to the chassis of the vehicle.

8. The drive system of any of the preceding claims, wherein each track is a reinforced rubber track.

9. The drive system of any of the preceding claims, which includes for each track at least one track guide positioned along an edge portion of the track for countering lateral displacement of the track.

10. The drive system of any of the preceding claims, which is configured to permit it to be fitted to the vehicle upon demand and to be removed when not required.
